(19) United States
(12) Patent Application Publication
(10) Pub. No.: US 2024/0375073 A1
(43) Pub. Date: Nov. 14, 2024

(54) METHOD AND APPARATUS FOR TREATING RAW MATERIAL AND USE

(71) Applicant: Teknologian tutkimuskeskus VTT Oy, Espoo (FI)

(72) Inventors: Matti Nieminen, VTT (FI); Juho Peltola, VTT (FI); Timo Niemi, VTT (FI); Janne Sami Keränen, VTT (FI)

(73) Assignee: Teknologian tutkimuskeskus VTT Oy, Espoo (FI)

(21) Appl. No.: 18/291,862

(22) PCT Filed: Aug. 9, 2022
(86) PCT No.: PCT/FI2022/050517

§ 371 Date: Jan. 24, 2024

(30) Foreign Application Priority Data
Aug. 10, 2021 (FI) 20215844

(51) Int. Cl. B01J 8/38; B01J 8/26; B01J 8/42

(52) U.S. Cl. CPC B01J 8/388; B01J 8/26; B01J 8/42; B01J 2208/00106; B01J 2208/00433; B01J 2208/00761

(57) ABSTRACT

A method and apparatus for treating raw material in a fluidized bed reactor comprising at least two bed materials are provided. The second bed material is subjected into a lower part of the fluidized bed reactor that includes first the bed material having electroconductive material. A fluidizing agent is fed to a bottom of the fluidized bed reactor, and the fluidizing agent flows through the lower part of the reactor to an upper part of the fluidized bed reactor. The first bed material is inductively heated and heat is transferred from the first bed material to the fluidizing agent and/or to the second bed material in the lower part of the reactor. The heated second bed material is fluidized by the fluidizing agent to the upper part of reactor. The raw material is fed to the upper part of the reactor where the raw material is treated.

### CROSS-REFERENCE TO RELATED APPLICATIONS

This application is a national phase entry of and claims priority to International Patent Application No. PCT/FI2022/050517 (filed 9 Aug. 2022), which claims priority to Finnish Patent Application No. 20215844 (filed 10 Aug. 2021), the entire disclosures of which are incorporated herein by reference.

### BACKGROUND

### Technical Field

The application relates to a method and an apparatus for treating raw material in a fluidized bed reactor. Further, the application relates to a use of the apparatus.

### Description of Related Art

Known from the prior art is to treat different raw materials in fluidized bed reactors. A fluidizing agent is used in the fluidized bed reactor.

Further, it is known an electrical heating. However, the electrical heating of fluidized bed reactor is difficult to high operating temperatures.

### BRIEF SUMMARY

A new type of heating procedure is provided, when raw material is treated in a fluidized bed reactor. Further, a new way to heat a fluidizing agent by an inductive heating is provided. Further, an arrangement to heat the fluidized bed reactor without direct contact between electroconductive materials, e.g. ferromagnetic materials, and raw material in a reaction area is provided.

In the method and apparatus, raw material is treated in a fluidized bed reactor which comprises at least two bed materials. The fluidized bed reactor is heated by an indirect inductive heating.

### BRIEF DESCRIPTION OF THE DRAWINGS

The accompanying drawings, which are included to provide a further understanding of the invention and constitute a part of this specification, illustrate some embodiments of the invention and together with the description help to explain the principles of the invention. In the drawings:

FIG. 1 shows a process arrangement according to one embodiment,

FIG. 2 shows a process arrangement according to another embodiment, and

FIG. 3 shows a process arrangement according to another embodiment.

### DETAILED DESCRIPTION

In the method raw material is treated in a fluidized bed reactor which comprises at least two bed materials. The second bed material, e.g. comprising particles, is subjected into a lower part of the fluidized bed reactor in which the lower part of the reactor comprises the first bed material comprising electroconductive material, e.g. particles, and fluidizing agent is fed to a bottom of the fluidized bed reactor and the fluidizing agent is arranged to flow through the lower part of the reactor to an upper part of the reactor. The first bed material is heated by induction heating in the lower part of the reactor and heat is transferred from the first bed material to the fluidizing agent and/or to the second bed material in the lower part of the reactor. The heated second bed material is fluidized by the fluidizing agent to the upper part of reactor, and the raw material is fed to the upper part of the fludized bed reactor where the raw material is treated to form a product.

The apparatus for treating raw material in a fluidized bed reactor comprises the fluidized bed reactor comprising at least two bed materials. The fluidized bed reactor comprises a lower part of the reactor and an upper part of the reactor, at least one bed material inlet for subjecting the second bed material into the lower part of the reactor in which the lower part of the reactor comprises the first bed material comprising electroconductive material, at least one induction heating device for heating the first bed material by induction heating in the lower part of the reactor, at least one gas inlet for feeding a fluidizing agent to a bottom of the fluidized bed reactor and for arranging the fluidizing agent to flow through the lower part of the reactor where heat is transferred from the first bed material to the fluidizing agent and/or to the second bed material and to flow to the upper part of the reactor such that the heated second bed material is fluidized by the fluidizing agent from the lower part to the upper part of reactor, at least one feed inlet for feeding the raw material to the upper part of the reactor where the raw material is treated, and at least one outlet for discharging a product out from the reactor.

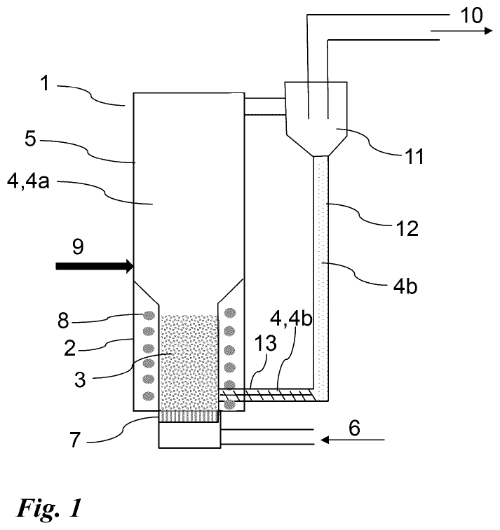

Some embodiments of the method and the apparatus are shown in FIGS. 1, 2 and 3.

The fluidized bed reactor may be any reactor having at least one fluidized bed. In this context, the fluidized bed reactor comprises at least two bed materials. In one embodiment, the fluidized bed reactor comprises one fluidized bed. In one embodiment, the fluidized bed reactor comprises at least two fluidized beds. In one embodiment, a dense bed of the lower part of the reactor behaves like a bubbling fluidized bed. In one embodiment, at least the lower part of the reactor is a bubbling fluidized bed. In one embodiment, a bed in the upper part of the reactor behaves like a circulating fluidized bed. In one embodiment, the lower part of the reactor is a bubbling fluidized bed and the upper part of the reactor is a circulating fluidized bed. In one embodiment, the lower part of the reactor is a bubbling fluidized bed and the upper part of the reactor is a bubbling fluidized bed. In one embodiment, the raw material is treated for forming a product, e.g. gas or a product gas, in the fluidized bed reactor, such as in the upper bed of the fluidized bed reactor. The raw material is fluidized with the fluidizing agent in the fluidized bed reactor, such as in the upper bed of the fluidized bed reactor. In one embodiment, the upper bed of the reactor is an actual reaction bed. In one embodiment, the fluidized bed reactor is designed so that the lower part of the reactor comprises a bed, e.g. a bubbling fluidized bed, comprising heavier first bed material particles and the upper part of the reactor comprises an actual reaction bed, e.g. a circulating fluidized bed, comprising lighter second bed material particles. The lighter second bed material particles may be circulated and returned back to the lower part of the reactor.

In this context, the fluidizing agent means any suitable fluidizing agent, e.g. steam, gaseous agent, fluidizing gas, gas mixture or the like or their combination. In one embodiment, the fluidizing agent comprises steam. In one embodiment, the fluidizing agent is steam.

In this context, the raw material means any suitable material which can be treated in the fluidized bed reactor. In one embodiment, the raw material may comprise plastic.

In one embodiment, the fluidized bed reactor is a circulating fluidized bed (CFB) reactor. In one embodiment, the fluidized bed reactor is a bubbling fluidized bed (BFB) reactor. In one embodiment, the fluidized bed reactor is a combination of a circulating fluidized bed reactor and bubbling fluidized bed reactor.

In one embodiment, the fluidized bed reactor is a fluidized bed gasifier or a fluidized bed pyrolizer in which the raw material is treated for forming gas, such as product gas. In one embodiment, the fluidized bed reactor is the fluidized bed gasifier, and the gasification is carried out in the upper part of the reactor. In one embodiment, the fluidized bed reactor is the fluidized bed pyrolizer, and the pyrolysis is carried out in the upper part of the reactor. In one embodiment, the gasification or the pyrolysis in the reactor is performed by steam. The gasification or the pyrolysis is a process that converts the raw material into products, such as into the gas, e.g. gasification gas or pyrolysis gas. This can be achieved by treating the raw material at suitable temperatures, and for example, with a controlled amount of the steam. Any suitable gasifier or pyrolizer may be used in the present process. In one embodiment, the gasifier or the pyrolizer is a circulating fluidized bed (CFB) reactor. In one embodiment, the gasifier or the pyrolizer is a bubbling fluidized bed (BFB) reactor. The raw material in the gasification or pyrolysis may comprise any components, e.g. plastic and other components. For example, the raw material can comprise also aluminum, e.g. aluminum foil, especially if a BFB reactor is used. In one embodiment, the raw material comprising plastic is gasified in the fluidized bed reactor, such as in the fluidized bed gasifier. In one embodiment, the raw material comprising plastic is pyrolyzed in the fluidized bed reactor, such as in the fluidized bed pyrolizer.

In one embodiment, the upper part of the reactor is a reaction area, e.g. a reaction chamber, such as an actual reaction chamber, in which the raw material is treated.

In the method and apparatus, the heat is transferred from the first bed material to the fluidizing agent and/or to the second bed material in the lower part of the reactor. The heat transfers from the first bed material to the fluidizing agent, and further the heat transfers to the second bed material. Further, the heat transfers from the fluidizing agent to the second bed material.

In one embodiment, the second bed material comprises non-electroconductive material. In one embodiment, the second bed material comprises non-ferromagnetic material. In one embodiment, the second bed material includes sand, alumina, dolomite, other non-electroconductive material or their combination. In one embodiment, the second bed material is formed from particles, i.e. the second bed material includes non-electroconductive material particles. In one embodiment, the second bed material acts as an actual bed material of the reaction in the upper part of the reactor, e.g. in an actual fluidized bed reaction area, such as reaction chamber.

The first bed material comprises electroconductive material. In one embodiment, the first bed material comprises ferromagnetic material. In one embodiment, the first bed material is formed from particles, i.e. the first bed material includes electroconductive material particles. In one embodiment, the first bed material comprises ferromagnetic particles. In one embodiment, the first bed material stays in the lower part of the reactor, e.g. in a bubbling fluidized bed part. Previously, it has been observed that a use of the ferromagnetic material is challenging in the heating if the ferromagnetic material has a direct contact with raw material in a reaction area. The ferromagnetic materials may have unwanted catalytic impacts. The process of the present application solves these problems in the heating in which the ferromagnetic material is used.

In one embodiment, the first bed material comprises heavier, e.g. coarser, particles than the second bed material. In one embodiment, the second bed material comprises lighter particles than the first bed material. In one embodiment, the second bed material comprises finer particle size material than the first bed material. In one embodiment, the particle sizes of the first and second bed materials are dependent on reactor design, densities of the bed materials and/or fluidizing velocity. For example, when the first bed material comprises heavier particles and the second bed material comprises lighter particles, the first bed material can be kept in the lower part of the reactor and the first bed material particles do not move along to the upper part of the reactor.

In one embodiment, the heating is carried out indirectly in the fluidized bed reactor without a contact of the first bed material with reaction components or with a minimum m contact of the first bed material with reaction components. In this context, the term ‘minimum contact’ means that a contact between the first bed material and reaction components, such as the raw material, is decreased significantly or is avoided. In one embodiment, particle size of the first bed material is selected such that the first bed material can be kept in the lower part of the reactor and the first bed material particles do not move to the upper part of the reactor in which the raw material is fed to the reactor. In one embodiment, less than 1% (by volume) of the raw material has a contact with the first bed material. In one embodiment, the treatment of the raw material in the fluidized bed reactor is arranged so that the raw material is treated in the upper part of the reactor without the first bed material in this actual reaction area of the upper part. The electroconductive material, especially ferromagnetic material, may have catalytic effects, and thus the electroconductive material is not arranged to contact with the reaction components, such as with the raw material.

Any suitable induction heating device may be used as the induction heating device. In one embodiment, the induction heating device comprises at least one induction coil. In one embodiment, the lower part of the fluidized bed reactor is surrounded by induction coils enabling the inductive heating the first bed material. In one embodiment, the first bed material comprising heavier particles is heated by the induction heating device in the lower part of the reactor, at least the fluidizing agent is heated by the first bed material, and the second bed material comprising lighter particles are heated at least by the fluidizing agent and optionally by the first bed material when the particles of the second bed material penetrate through the first bed material. In one embodiment, the first bed material may act as a solid-solid heat exchanger for heating the second bed material.

In one embodiment, the particles of the first bed material are moved, e.g. fluidized, in the lower part of the reactor. The particles of the first bed material may be moved, e.g. fluidized, among the second material by the fluidizing agent in the lower part. When the particles of the first bed material are moved, the particles can be heated effectively and evenly.

In one embodiment, the induction heating device is operated by electricity generated by renewable energy, such as by wind power, solar energy and/or nuclear power. In one embodiment, the electricity is generated without fossil fuels. Then the process can be performed CO-emission free. Further, by means of the electrical heating a combustion of fossil fuels can be avoided for producing heat to the fluidized bed reactor, and thus the process can be performed CO₂ emission free.

In one embodiment, the product comprises the second bed material, and the second bed material is separated from the product of the fluidized bed reactor after the fluidized bed reactor, especially when a circulating fluidized bed reactor (CFB) is used. In one embodiment, the product is supplied from the fluidized bed reactor to a separating device in which at least second bed material is separated. In one embodiment, the apparatus comprises at least one separating device for separating the second bed material from the product after the fluidized bed reactor. In one embodiment, the separating device may be a cyclone or other suitable separating device, separator or the like or their combination.

In one embodiment, the second bed material is circulated from the fluidized bed reactor to a separating device and from the separating device back to the lower part of the fluidized bed reactor, especially when a circulating fluidized bed reactor (CFB) is used. In one embodiment, the apparatus comprises means for circulating the second bed material from the fluidized bed reactor to a separating device and from the separating device back to the lower part of the fluidized bed reactor.

In one embodiment, the product is supplied from the fluidized bed reactor to the separating device in which at least second bed material is separated, and the product is discharged from the separating device, and the second bed material separated in the separating device is fed to the lower part of the fluidized bed reactor.

In one embodiment, the second bed material is circulated from the upper part of the fluidized bed reactor to the lower part of the fluidized bed reactor by means of a circulation tube, e.g. an overflow pipe or tube, especially when a bubbling fluidized bed (BFB) reactor is used. In one embodiment, the second bed material is arranged to flow from the upper part to the lower part and is arranged to penetrate to the bed of the lower part of the fluidized bed reactor, especially to a bottom or lower section of the bed of the lower part. The penetration of the second bed material into the bed of the lower part of the fluidized bed reactor may be facilitated by using a feeding gas and/or by using a gas blowing or a steam blowing. In one embodiment, the apparatus comprises at least one circulation tube, e.g. overflow pipe or tube, for circulating the second bed material from the upper part of the fluidized bed reactor to the lower part of the fluidized bed reactor. In one embodiment, the apparatus comprises a gas blowing device, e.g. a steam blowing device, or a gas ejector, e.g. a steam ejector, for facilitating the penetration of the second bed material into the bed of the lower part of the fluidized bed reactor. In one embodiment, the feeding gas may be steam, vapor, process gas, recirculated gas, thermally treated material, other gas or their combination.

In one embodiment, the product, e.g. a product gas, from the fluidized bed reactor is cooled in a cooling device, e.g. in a water quench or a heat exchanger, after the fluidized bed reactor.

In one embodiment, the raw material comprising plastic is gasified in the fluidized bed gasifier in which steam is used as the fluidizing agent. The gasification may be carried out at 680-760° C. The raw material comprising plastic may comprise polyolefins and/or recycled plastics. In one embodiment, the raw material consists of polyolefins and/or recycled plastics. In this context, the recycled plastics means any plastic mixture which consists of one or more polymers. The recycled plastics may comprise polyolefins, e.g. polyethylene or polypropylene, and other polymers, and further other components, such as paper, cardboard and/or aluminum material. In one embodiment, the recycled plastics may comprise also PVC plastic. In one embodiment, the product gas may comprise olefins, e.g. ethylene and propylene, and the product gas may be rich in olefins. Further, the product gas may comprise aromatics, e.g. benzene and toluene, and other hydrocarbons, e.g. butadiene. Usually, the product gas is a mixture of hydrocarbons. In one embodiment, the product gas is cooled after the gasifier for killing chemical reactions after the gasification. In one embodiment, the product gas is cooled by a heat exchanger or a water quench. In one embodiment, reactions are killed rapidly after the gasification by cooling the product gas to temperature of below 600° C., in one embodiment below 580° C. and in one embodiment below 550° C., in order to stop chemical reactions. In one embodiment, reactions are killed rapidly after the gasification by cooling the product gas to temperature of 580-600° C. When the reactions are killed, the yield of targeted products, e.g. light olefins, may be increased or maximized.

The method and apparatus are based on a continuous process.

In one embodiment, the method and apparatus can be used in a production of hydrocarbons, treatment of plastic containing raw material, gasification, pyrolysis, heat-treatment process, catalytic cracking or their combinations.

Thanks to the invention, the fluidizing agent can be heated by the indirect inductive heating easily and effectively without problems in the process. In the present invention, the inductive heating enables heating of the actual bed material, i.e. second bed material, without contact between reaction components and electroconductive material, e.g. ferromagnetic material. By means of invention, the heating can be done CO emission free. Further, raw material can be treated and the process can be performed CO-emission free.

The method and apparatus offer a possibility to heat the fluidizing agent and to treat raw material energy- and cost-effectively. The present invention provides an industrially applicable, simple and affordable way to heat the fluidizing agent and to treat raw material. The method and apparatus are easy and simple to realize in connection with production processes.

Further, the recycling of plastics can be improved by means of the invention.

### EXAMPLES

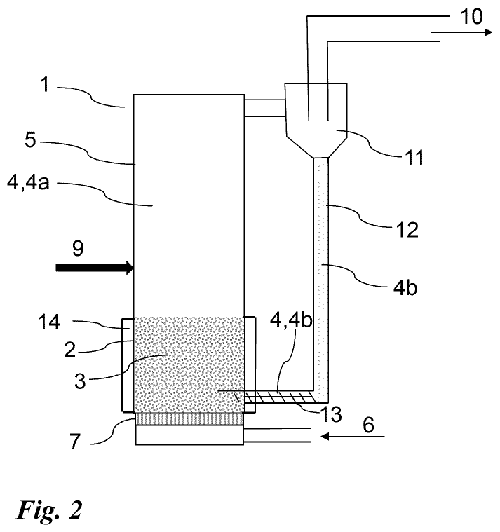

FIGS. 1 and 2 present some embodiments of the process in which raw material is treated in a circulating fluidized bed reactor, which is a gasifier in this process, and in which the process is heated by an indirect inductive heating.

The fluidized bed reactor (1), which is a CFB gasifier, comprises two bed materials, a first bed material and a second bed material. The fluidized bed reactor comprises a lower part (2) of the reactor and an upper part (5) of the reactor. The lower part comprises the first bed material (3) comprising electroconductive material particles, e.g. ferromagnetic particles, and the upper part comprises the second bed material (4) comprising non-electroconductive material particles, e.g. non-ferromagnetic particles. The first bed material forms a bubbling fluidizing bed in the lower part where the first bed material particles is moved among the second material by the fluidizing agent. The second bed material forms an actual fluidizing reaction bed in the upper part, which is an actual reaction chamber. The first bed material comprises heavier particles and the second bed material comprises finer particles. The first bed material particles (3) are heavy enough not to enter to the actual reaction chamber (5) where the fluidized bed is formed only by the finer second bed material particles (4), and thus contact between the first bed material and reaction components, such as the raw material (9), is avoided.

Further, the apparatus of FIGS. 1 and 2 comprises a bed material inlet for subjecting the second bed material into the lower part of the reactor and a gas inlet for feeding a fluidizing agent (6) to a bottom (7) of the fluidized bed reactor. The fluidizing agent is arranged to flow through the lower part of the reactor where heat is transferred from the first bed material to the second bed material and to the fluidizing agent and to flow to the upper part of the reactor such that the heated second bed material (4a) is fluidized by the fluidizing agent from the lower part to the upper part of reactor and in the upper part of the reactor. Further, the apparatus comprises a feed inlet for feeding the raw material (9) to the upper part of the reactor where the raw material is treated, and an outlet for discharging a product (10) which comprises the second bed material out from the reactor.

Further, the apparatus of FIG. 1 comprises an induction heating device comprising induction coils (8) for heating the first bed material (3) by induction heating in the lower part of the reactor (2). The lower part of the fluidized bed reactor is surrounded by induction coils. The apparatus of FIG. 2 comprises an induction heating device (14) for heating the first bed material (3) by induction heating in the lower part of the reactor (2). The heating is carried out indirectly in the fluidized bed reactor without a contact of the first bed material with reaction components of the raw material (9). The first bed material comprising heavier particles is heated by the induction heating in the lower part, at least the fluidizing agent is heated by the first bed material, and the second bed material comprising lighter particles are heated at least by the fluidizing agent and optionally by the first bed material when the particles of the second bed material penetrate through the first bed material. Then the fluidizing agent acts as a medium of the heat transfer for improving the transfer of heat and the heating of the second bed material.

Further, the apparatus of FIGS. 1 and 2 comprises means for circulating the second bed material from the fluidized bed reactor (1), i.e. from the upper part (5), to a separating device (11), which is a cyclone in this process, and from the separating device (11) back to the lower part (2) of the reactor. The product (10) is supplied to the separating device in which the second bed material is separated. The product (10) is discharged from the separating device. The second bed material (4b) separated in the separating device is circulated via a pipe (12) and fed by means of a feeder (13) to the lower part (2) of the reactor.

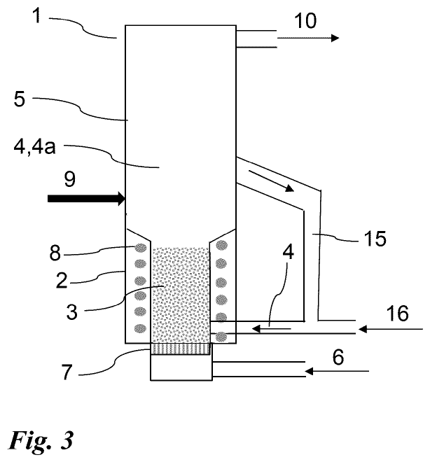

FIG. 3 presents some embodiments of the process in which raw material is treated in a bubbling fluidized bed reactor, which is a gasifier in this process, and in which the process is heated by an indirect inductive heating.

The fluidized bed reactor (1) of FIG. 3, which is a BFB gasifier, comprises two bed materials, a first bed material and a second bed material. The fluidized bed reactor comprises a lower part (2) of the reactor and an upper part (5) of the reactor. The lower part comprises the first bed material (3) comprising electroconductive material particles, e.g. ferromagnetic particles, and the upper part comprises the second bed material (4) comprising non-electroconductive material particles, e.g. non-ferromagnetic particles. The first bed material forms a bubbling fluidizing bed in the lower part where the first bed material particles is moved among the second material by the fluidizing agent. The second bed material forms an actual reaction bed in the upper part, which is an actual reaction chamber. The first bed material comprises heavier particles and the second bed material comprises finer particles. The first bed material particles (3) are heavy enough not to enter to the actual reaction chamber (5) where the fluidized bed is formed only by the finer second bed material particles (4), and thus contact between bed the first material and reaction components, such as the raw material (9), is avoided.

Further, the apparatus of FIG. 3 comprises a bed material inlet for subjecting the second bed material into the lower part of the reactor and a gas inlet for feeding a fluidizing agent (6) to a bottom (7) of the fluidized bed reactor. The fluidizing agent is arranged to flow through the lower part of the reactor where heat is transferred from the first bed material to the second bed material and to the fluidizing agent and to flow to the upper part of the reactor such that the heated second bed material (4a) is fluidized by the fluidizing agent from the lower part to the upper part of reactor and in the upper part of the reactor. Further, the apparatus comprises a feed inlet for feeding the raw material (9) to the upper part of the reactor where the raw material is treated, and an outlet for discharging a product (10) out from the reactor.

Further, the apparatus of FIG. 3 comprises an induction heating device comprising induction coils (8) for heating the first bed material (3) by induction heating in the lower part of the reactor (2). The lower part of the fluidized bed reactor is surrounded by induction coils. The heating is carried out indirectly in the fluidized bed reactor without a contact of the first bed material with reaction components of the raw material (9). The first bed material comprising heavier particles is heated by the induction coils in the lower part, at least the fluidizing agent is heated by the first bed material, and the second bed material comprising lighter particles are heated at least by the fluidizing agent and optionally by the first bed material when the particles of the second bed material penetrate through the first bed material. Then the fluidizing agent acts as a medium of the heat transfer for improving the transfer of heat and the heating of the second bed material.

Further, the apparatus of FIG. 3 comprises means for circulating the second bed material from the upper part (5) of the fluidized bed reactor (1) back to the lower part (2) of the reactor. The second bed material is circulated via an overflow tube (15) to the lower part (2) of the reactor. The second bed material is arranged to penetrate into the bed of the lower part of the fluidized bed reactor, especially into the lower section of the bed. The penetration of the second bed material into the bed of the lower part of the fluidized bed reactor is facilitated by using a feeding gas (16) which is steam or other suitable gas. The apparatus may comprise a gas/steam blowing device or a gas/steam ejector for facilitating the penetration of the second bed material into the bed of the lower part of the fluidized bed reactor. A recycling rate can be adjusted by feeding rate of the feeding gas.

Any suitable devices and equipment can be used in the processes of FIGS. 1-3.

The method and apparatus are suitable in different embodiments for treating different raw materials in different fluidized bed reactors and for heating different fluidizing agents by an indirect inductive heating in different fluidized bed processes.

The invention is not limited merely to the examples referred to above; instead many variations are possible within the scope of the inventive idea defined by the claims.

1. A method for treating raw material in a fluidized bed reactor (1) which comprises at least two bed materials, characterized in that the method comprises steps
subjecting the second bed material (4), which comprises non-electroconductive material, into a lower part (2) of the fluidized bed reactor in which the lower part of the reactor comprises the first bed material (3) comprising electroconductive material, and feeding a fluidizing agent (6) to a bottom (7) of the fluidized bed reactor and arranging the fluidizing agent to flow through the lower part of the reactor to an upper part (5) of the fluidized bed reactor,
heating the first bed material (3) by induction heating in the lower part (2) of the reactor and transferring heat from the first bed material to the fluidizing agent (6) and to the second bed material (4,4b) in the lower part of the reactor,
fluidizing the second bed material (4a), which is heated in the lower part of the reactor, by the fluidizing agent to the upper part (5) of reactor, and
feeding the raw material (9) to the upper part of the reactor where the raw material is treated.

2. The method according to claim 1, characterized in that the second bed material (4,4b) is separated from a product (10) of the fluidized bed reactor after the fluidized bed reactor (1).

3. The method according to claim 1, characterized in that the second bed material (4,4b) is circulated from the fluidized bed reactor (1) to a separating device (11) and from the separating device back to the lower part (2) of the reactor.

4. The method according to claim 1, characterized in that the second bed material (4) is circulated from the upper part (5) of the fluidized bed reactor to the lower part (2) of the fluidized bed reactor by means of a circulation tube (15).

5. The method according to claim 1, characterized in that the first bed material (3) comprises ferromagnetic material.

6. (canceled)

7. The method according to claim 1, characterized in that the heating is carried out indirectly in the fluidized bed reactor (1) without a contact of the first bed material (3) with reaction components of the raw material or with a minimum contact of the first bed material with reaction components of the raw material.

8. The method according to claim 1, characterized in that the upper part (5) of the reactor is a reaction chamber in which the raw material (9) is treated.

9. The method according to claim 1, characterized in that the fluidized bed reactor (1) is a fluidized bed gasifier or a fluidized bed pyrolyzer, and gasification or pyrolysis is carried out in the upper part (5) of the reactor.

10. The method according to claim 1, characterized in that the raw material (9) comprising plastic is gasified or pyrolyzed in the fluidized bed reactor.

11. An apparatus for treating raw material in a fluidized bed reactor, in which the apparatus comprises the fluidized bed reactor (1) comprising at least two bed materials, characterized in that the fluidized bed reactor comprises
a lower part (2) of the reactor and an upper part (5) of the reactor,
at least one bed material inlet for subjecting the second bed material (4,4b), which comprises non-electroconductive material, into the lower part of the reactor in which the lower part of the reactor comprises the first bed material (3) comprising electroconductive material,
at least one induction heating device (8,14) for heating the first bed material by induction heating in the lower part of the reactor,
at least one gas inlet for feeding a fluidizing agent (6) to a bottom (7) of the fluidized bed reactor and for arranging the fluidizing agent to flow through the lower part of the reactor where heat is transferred from the first bed material to the fluidizing agent and to the second bed material and to flow to the upper part of the reactor such that the second bed material, which is heated in the lower part of the reactor, is fluidized by the fluidizing agent from the lower part to the upper part of reactor,
at least one feed inlet for feeding the raw material (9) to the upper part of the reactor where the raw material is treated, and
at least one outlet for discharging a product (10) out from the fluidized bed reactor.

12. The apparatus according to claim 10, characterized in that the induction heating device comprises at least one induction coil (8).

13. The apparatus according to claim 10, characterized in that the lower part (2) of the fluidized bed reactor is arounded by induction coils (8).

14. The apparatus according to claim 10, characterized in that the apparatus comprises at least one separating device (11) for separating the second bed material (4b) from the product (10) after the reactor.

15. The apparatus according to claim 10, characterized in that the apparatus comprises means for circulating the second bed material (4b) from the fluidized bed reactor (1) to a separating device (11) and from the separating device back to the lower part (2) of the reactor.

16. The apparatus according to claim 10, characterized in that the apparatus comprises at least one circulation tube (15) for circulating the second bed material (4) from the upper part (5) of the fluidized bed reactor to the lower part (2) of the fluidized bed reactor.

17. The apparatus according to claim 10, characterized in that the apparatus comprises a gas blowing device or a gas ejector for facilitating to penetration of the second bed material (4) into a bed of the lower part (2) of the fluidized bed reactor.

18. The apparatus according to claim 10, characterized in that the fluidized bed reactor (1) is a circulating fluidized bed reactor or a bubbling fluidized bed reactor.

19. The apparatus according to claim 10, characterized in that the fluidized bed reactor (1) is a fluidized bed gasifier or a fluidized bed pyrolyzer.

20. The apparatus according to claim 10, characterized in that the induction heating device is operated by electricity generated by renewable energy, such as by wind power, solar energy and/or nuclear power.

21. A use of the apparatus according to claim 10, characterized in that the apparatus is used in a production of hydrocarbons, treatment of plastic containing raw material, gasification, pyrolysis, heat-treatment process, catalytic cracking or their combinations.
